(19) United States
(12) Patent Application Publication
(10) Pub. No.: US 2025/0290369 A1
(43) Pub. Date: Sep. 18, 2025

(54) AUTOMATICALLY OPENABLE AND CLOSABLE DOOR

(71) Applicant: US EIWO INC, ONTARIO, CA (US)

(72) Inventor: Yong WU, Ontario, CA (US)

(21) Appl. No.: 19/228,462

(22) Filed: Jun. 4, 2025

(30) Foreign Application Priority Data
Apr. 18, 2025 (CN) 202520742342.4

(51) Int. Cl. E05F 15/614; A01K 31/02

(52) U.S. Cl. CPC E05F 15/614; A01K 31/02; E05Y 2400/30; E05Y 2900/00

(57) ABSTRACT

An automatically openable and closable door includes: a door body, a driving device, and a transmission mechanism. The driving device includes a driving mechanism and a control mechanism, the driving mechanism is provided with a driving motor, and one side of the driving motor is provided with a first space; and the door body is connected to the driving motor, so as to be driven to rotate; where after being inserted into the first space, the door body is capable of rotating clockwise or counterclockwise to switch from a closed state to an open state.

### TECHNICAL FIELD

The present invention relates to the technical field of openable and closable devices, and in particular, to an automatically openable and closable door.

### BACKGROUND

For poultry bred using a breeding cage, in order to make the poultry have a large enough activity space, a cage door is generally mounted on the breeding cage. When the cage door is opened at daytime, the poultry can run to a designated activity area. This breeding mode enables the poultry to get sufficient exercises and breathe fresh air, and can improve the quality of the poultry.

However, in an actual breeding process, most of the cage doors are opened and closed manually. In small-scale family breeding, although the workload is not large, it is easy to forget to open the cage door during the daytime and close the cage door at night. However, in large-scale breeding, not only is the workload heavy, but it is also easy to miss the opening and closing of some breeding cages. With this regard, Chinese invention patent publication No. CN217608950U, entitled “AUTOMATICALLY OPENABLE AND CLOSABLE DOOR”, provides a chicken cage door, which includes a door leaf and a door frame, further includes a driving device driving the door leaf to slide up and down along the door frame, a controller and a photosensitive sensor, and can automatically open the chicken cage at dawn and automatically close the chicken cage door when it is dark. However, for the chicken cage door, the door is slidably opened and closed through a track, and the track would be easily stuck by foreign matters, thereby causing a failure of opening and closing the door.

### SUMMARY

The present invention aims to solve at least one of the technical problems existing in the prior art or related art.

In view of the above, the present invention provides an automatically openable and closable door, including: a door body, rotatably disposed to switch between an open state and a closed state; a driving device, configured to drive the door body to rotate, the driving device including a control mechanism and a driving mechanism, the driving mechanism being provided with a driving motor, and one side of the driving motor being provided with a first space in which the door body is inserted; and a transmission mechanism, including a first transmission member and a second transmission member, which are respectively disposed on the door body and the driving mechanism and coupled to each other, the second transmission member being connected to the driving motor, and the door body being connected to the driving motor to be driven thereby to rotate; where after the door body is inserted into the first space, the door body is capable of rotating clockwise or counterclockwise to switch from the closed state to the open state.

According to an implementation of the present invention, upper and lower sides of the driving motor are respectively provided with a second space and the first space; the door body is inserted in one of the first space and the second space, the door body is capable of rotating clockwise or counterclockwise to switch from the closed state to the open state, and the door body is detachably connected with the driving motor, so that the door body is mounted in the first space or the second space. Thus, the door body can be selectively mounted in one of the first space and the second space as desired, allowing the door body is allowed to open by turning left or turning right.

Compared with the prior art, the present application includes at least the following beneficial effects: in one or more embodiments provided by the present application, the automatically openable and closable door includes a door body, a driving device for driving the door body to rotate, and a transmission mechanism for connecting the door body and the driving device. The driving device includes a control mechanism and a driving mechanism mounted on the control mechanism, the driving mechanism is provided with a driving motor, and one side of the driving motor is provided with a first space. After the door body is connected to the driving device through the transmission mechanism, the door body is inserted in the first space, and the driving motor can drive the door body to rotate clockwise to switch from an initial closed state to the open state. Accordingly, in the automatically openable and closable door provided in this example, the door body is connected to the driving motor to drive the door body to rotate by the driving motor to realize the opening and closing of the door. The size of the door body can be flexibly set in a no-track design, so that the automatically openable and closable door can meet more mounting requirements.

### BRIEF DESCRIPTION OF THE DRAWINGS

Various other advantages and benefits will become apparent to persons having ordinary skill in the art upon reading the following detailed description of preferred implementations. The accompanying drawings are used for a purpose of illustrating preferred implementations only, and are not to be considered as limiting the present application. Further, same reference numerals are used throughout the drawings to designate same parts. In the drawings:

FIG. 1 is a schematic structural diagram of a closed state of an automatically openable and closable door provided in a first embodiment of the present application;

FIG. 2 is a schematic structural diagram of an open state of an automatically openable and closable door provided in the first embodiment of the present application;

FIG. 3 is a schematic exploded structural diagram of a closed state of an automatically openable and closable door provided in a second embodiment of the present application;

FIG. 4 is a schematic structural diagram of a door body of an automatically openable and closable door provided in the second embodiment of the present application;

FIG. 5 is a section view of a driving device of an automatically openable and closable door provided in the second embodiment of the present application;

FIG. 6 is a partial schematic structural diagram of a driving device of an automatically openable and closable door provided in the second embodiment of the present application;

FIG. 7 is a partial schematic structural diagram of a driving device of an automatically openable and closable door provided in the second embodiment of the present application;

FIG. 8 is a schematic structural diagram of a mounting part of a driving device of an automatically openable and closable door provided in the second embodiment of the present application;

FIG. 9 is a schematic structural diagram of a first driving housing of a driving device of an automatically openable and closable door provided in the second embodiment of the present application;

FIG. 10 is a schematic structural diagram of a closed state of an automatically openable and closable door provided in a third embodiment of the present application;

FIG. 11 is a schematic structural diagram of an open state of an automatically openable and closable door provided in the third embodiment of the present application;

FIG. 12 is a schematic exploded structural diagram of a closed state of an automatically openable and closable door provided in the third embodiment of the present application; and

FIG. 13 is a schematic structural diagram of an open state of an automatically openable and closable door provided in a fourth embodiment of the present application.

### DESCRIPTION OF REFERENCE NUMERALS

100, door body; 110, connecting part; 111, limiting member; 120, stop part;
200, driving device; 210, control mechanism; 211, placement groove; 212, third mounting member; 2121, third upper mounting member; 2122, third lower mounting member; 220, driving mechanism; 221, driving motor; 222, second mounting member; 223, first driving housing; 224, second driving housing; 2241, fixing member; 225, control board; 226, battery compartment; 227, power switch; 228, charging port; 229, state determining member; 2291, first state determining member; 2292, second state determining member; 230, protrusion; 231, first mounting member;
300, first space;
400, second space;
500, transmission mechanism; 510, first transmission member; 520, second transmission member; 521, external gear; 522, cover plate.

### DESCRIPTION OF THE EMBODIMENTS

In order to make the above-mentioned objects, features and advantages of the present invention more obvious and more easily understood, specific implementations of the present invention will be described in detail below with reference to the accompanying drawings. Numerous specific details are set forth in the following description, to facilitate a full understanding of the present invention. However, the present invention can be practiced in many other ways than those described herein, and similar modifications can be made by persons skilled in the art without departing from the spirit of the invention, and therefore, the present invention is not limited by the specific embodiments disclosed below.

### First Embodiment

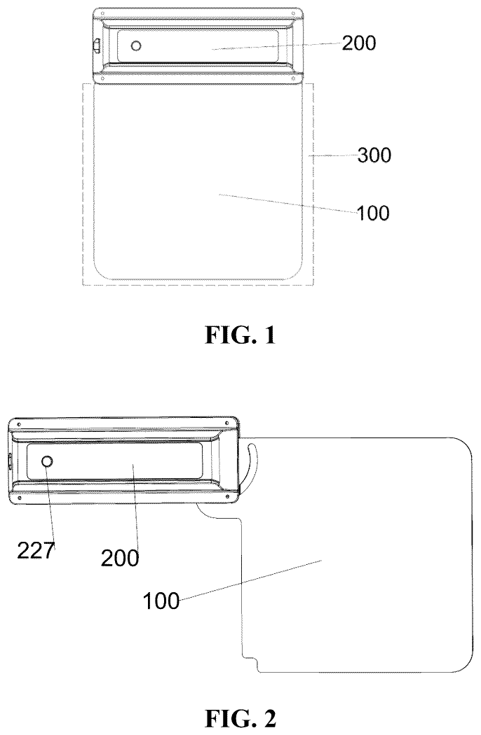

Referring to FIGS. 1 and 2, this embodiment provides an automatically openable and closable door, including: a door body 100, rotatably disposed to switch between an open state and a closed state; a driving device 200, configured to drive the door body 100 to rotate, the driving device 200 including a control mechanism and a driving mechanism, the driving mechanism being provided with a driving motor, and one side of the driving motor being provided with a first space 300; and a transmission mechanism, including a first transmission member and a second transmission member, which are respectively disposed on the door body and the driving mechanism and coupled to each other, the second transmission member being connected to the driving motor, and the door body 100 being connected to the driving motor to be driven thereby to rotate; where after the door body 100 is inserted into the first space 300, the door body 100 rotates clockwise or counterclockwise from an initial position to switch from the closed state to the open state.

In this embodiment, taking opening the door by turning right as an example, the first space 300 is disposed on a lower side of the driving motor, the driving motor is disposed on a right side of the driving mechanism, and the door body 100 can rotate counterclockwise from the closed state shown in FIG. 1 to the open state shown in FIG. 2. Accordingly, in the automatically openable and closable door provided in this example, the door body is connected to the driving motor to drive the door body to rotate by the driving motor to realize the opening and closing of the door. The size of the door body can be flexibly set in a no-track design, so that the automatically openable and closable door can meet more mounting requirements.

### Second Embodiment

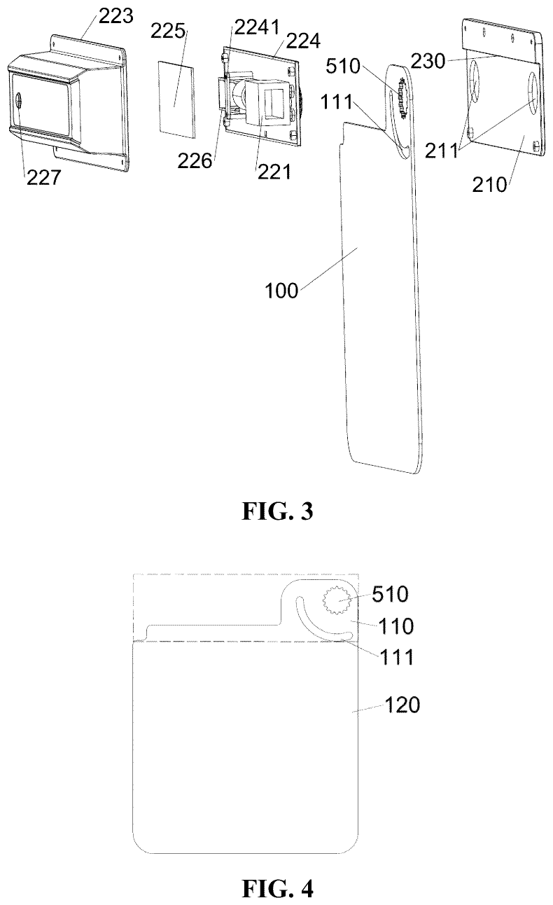

Referring to FIGS. 3 to 9, this embodiment provides an automatically openable and closable door, including: a door body 100, rotatably disposed to switch between an open state and a closed state; a driving device 200, configured to drive the door body 100 to rotate, the driving device 200 including a control mechanism 210 and a driving mechanism 220, the driving mechanism 220 being provided with a driving motor 221, and upper and lower sides of the driving motor 221 being respectively provided with a second space 400 and a first space 300; and a transmission mechanism 500, including a first transmission member 510 and a second transmission member 520, which are respectively disposed on the door body 100 and the driving mechanism 220 and coupled to each other, the second transmission member 520 being connected to the driving motor 221, and the door body 100 being connected to the driving motor 221 to be driven thereby to rotate; where the door body 100 is inserted into one of the first space 300 and the second space 400, the door body 100 rotates from an initial position clockwise or counterclockwise to switch from the closed state to the open state, and the door body 100 is detachably connected with the driving motor 221, so that the door body 100 is mounted in the first space 300 or the second space 400.

Specifically, in this embodiment, the mode of opening the door by turning right is adopted, the control mechanism 210 can be mounted above an entrance and exit of a breeding cage, the entrance and exit can be completely covered after the door body 100 is detachably connected to the driving motor 221, there is a gap between the bottom end of the door body 100 and the ground or other bottom surfaces, the gap can be used for the door body 100 to rotate in a vertical plane, and the distance between an upper end of the door body 100 and the ground or other bottom surfaces is not less than the length of a diagonal line of the door body 100. When the entrance and exit is in a closed state, the door body 100 is in the second space 300, and starting the driving motor 221 can drive the door body 100 to rotate counterclockwise to turn the entrance and exit into an open state. Thereafter, restarting the driving motor 221 can drive the door body 100 to rotate clockwise, to turn the entrance and exit into the closed state again.

It should be noted that in other embodiments, the control mechanism 210 may also be mounted below, on the left side, or on the right side of the entrance and exit.

Preferably, in this embodiment, as shown in FIGS. 3 to 8, the first transmission member 510 is a connecting groove disposed in the door body 100, and an inner wall of the connecting groove is provided with convex teeth. The second transmission member 520 includes an external gear 521, and the external gear 521 can be engaged with the convex teeth. Further, the connecting groove is disposed in a thickness direction of the door body 100 in a penetrating manner, the second transmission member 520 further includes a cover plate 522 detachably connected on the external gear 521, and the control mechanism 210 is provided with a placement groove 211 into which the cover plate 522 extends. After the door body 100 is detachably connected with the driving motor 221, the cover plate 522 abuts against at least a part of the convex teeth.

In this embodiment, the first transmission member 510 disposed on the door body 100 is a connecting groove penetrating therethrough and located at an upper right corner of the door body 100, the placement groove 211 is disposed on left and right sides of the control mechanism 210, the second transmission member 520 includes an external gear 521 and a cover plate 522, and an inner wall of the connecting groove is provided with convex teeth that can be engaged with the external gear 521. Further, when the door body 100 is mounted onto the drive device 200, the external gear 521 may be fitted to the connecting groove first, and then the cover plate 522 is connected to the external gear 521; and after the driving mechanism 220 is mounted onto the control mechanism 210, the cover plate 521 at least partially extends into the placement groove 211. Accordingly, it is possible to effectively prevent the door body 100 from being disengaged from the driving device 200 during use.

It should be noted that, in other embodiments, the connecting groove may not penetrate the door body 100, either; and two corresponding connecting grooves may be optionally provided on both sides of the door body 100, respectively. Two symmetrical connecting grooves can also be optionally provided on a same side of the door body 100, as long as the door body 100 can be fitted to and mounted in the first space 400 or the second space 300 in different mounting modes.

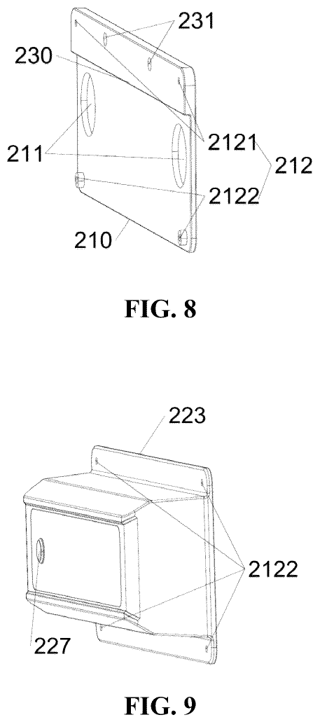

Preferably, as shown in FIG. 8, in this embodiment, the control mechanism 210 is provided with a protrusion 230 that protrudes toward the driving mechanism 220 and can abut against a back plate of the driving mechanism 220.

In this embodiment, the protrusion 230 is disposed above the transmission mechanism 500, which can prevent foreign matters from entering the transmission mechanism 500, thereby ensuring the effectiveness of the transmission mechanism 500, and prolonging the service life of the device.

Further, as shown in FIG. 8, in this embodiment, a first mounting member 231 is disposed on the protrusion 230, and the first mounting member 231 is used for mounting the control mechanism 210 above the entrance and exit.

Further, as shown in FIGS. 8 and 9, in this embodiment, the driving mechanism 220 and the control mechanism 210 are provided with a second mounting member 222 and a third mounting member 212, respectively, and the second mounting member 222 and the third mounting member 212 cooperate with each other to mount the driving mechanism 220 onto the control mechanism 210.

Specifically, in this embodiment, the control mechanism 210 is in a square shape, and the square shape is a central symmetrical pattern. The protrusion 230 is provided at the upper end of the control mechanism 210. The first mounting members 231 are disposed on the protrusion 230 at intervals, and specifically, the first mounting member may be a fixing hole penetrating the protrusion 230 and the mounting part 210, so that the mounting part 210 can be mounted and fixed above the entrance and exit by passing a locking member through the first mounting member 231. The third mounting members 212 are provided at four corners of the control mechanism 210, and specifically, the third mounting member may include a third upper mounting member 2121 and a third lower mounting member 2122 provided at the upper end. The third upper mounting member 2121 is a fixing hole penetrating the control mechanism 210, and the third lower mounting member 2122 is a mounting post provided with a fixing hole. The driving mechanism 220 is provided with a second mounting member 222 matching with the third mounting member 212, which specifically may be a fixing hole penetrating the driving mechanism 220, so that the locking member can be used for sequentially passing through the second mounting member 222 and the third mounting member 212 in alignment, so as to further mount and fix the driving mechanism 220 to the control mechanism 210. Accordingly, in other embodiments, the driving mechanism 220 may also rotate 180 degrees on the vertical plane and then mounted on the control mechanism 210, so that the door body 100 is mounted in the first space 400.

It should be noted that, in other embodiments, one or more of the first mounting member 231, the second mounting member 222, and the third mounting member 212 may have a non-fixing hole structure, for example, the second mounting member 222 and the third mounting member 212 may be snap-fit structures matching with each other, and may also be plug-in structures matching with each other, as long as the control mechanism 210 can be fixed to one side of the entrance and exit through the first mounting member 231, and the fixation between the driving mechanism 220 and the control mechanism 210 is realized through the second mounting member 222 and the third mounting member 212. Further, in other embodiments, a fourth mounting member corresponding to the first mounting member 231 may also be disposed on the driving mechanism 220, so that the driving mechanism 220 can be mounted on the control mechanism 210, and then the control mechanism 210 is mounted on one side of the entrance and exit.

Preferably, as shown in FIG. 4, in this embodiment, the door body 100 includes a connecting part 110 and a stop part 120 connected to a lower end of the connecting part 110, and the first transmission member 510 is disposed on the connecting part 110.

Further, as shown in the drawings, in this embodiment, in order to further limit the rotatable range of the door body 100 to ensure an automatic opening and closing benefit of the device, a limiting member 111 is further disposed on the connecting part 110.

Preferably, in this embodiment, as shown in FIGS. 3, 5, 6 and 9, the driving mechanism 220 includes a first driving housing 223 and a second driving housing 224, and the first driving housing 223 and the second driving housing 224 are closed to form an accommodating cavity; and the driving motor 221 is disposed on a right side of the accommodating cavity, including a transmission shaft extending out of the second driving housing 224, and the second transmission member 520 is fixed to the transmission shaft.

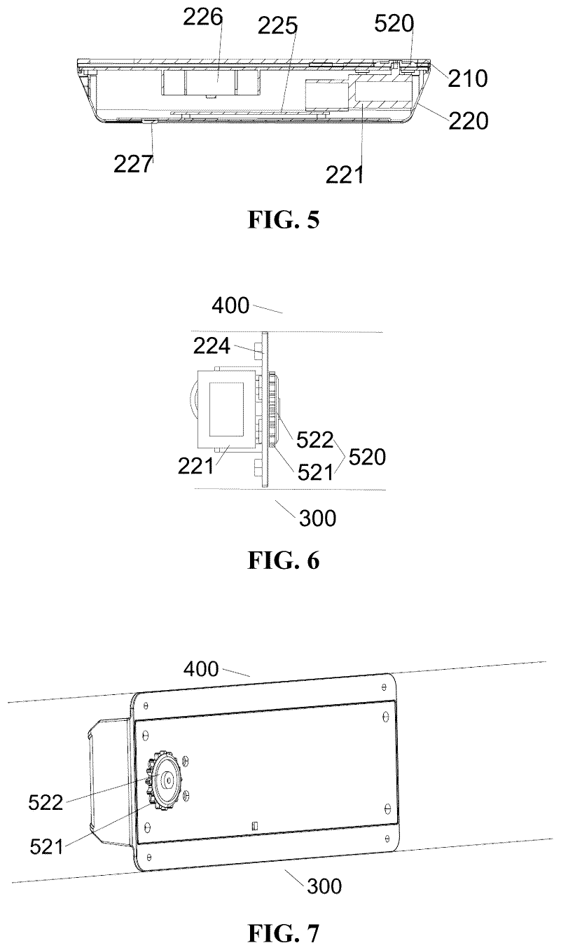

As a preferred embodiment, in this embodiment, as shown in FIGS. 3 and 5, a control board 225 is further provided in the accommodating cavity. A battery compartment 226 is provided in the accommodating cavity, and the battery compartment 226 is disposed on the left side of the driving motor 225. The first driving housing 223 is provided with a power switch 227. The first driving housing 223 is provided with a charging port 228 communicating with the accommodating cavity.

Specifically, in this embodiment, the first driving housing 223 includes a first part for being mounted on the control mechanism 210 and a second part having an accommodating space, the first part is connected to both upper and lower ends of the second part, and the second part protrudes from the first part. The second mounting member 222 is provided at both left and right ends of the first part, and corresponds to the position of the third mounting member 212 disposed on the control mechanism 210. After the first transmission member 510 on the door body 100 is connected to the second transmission member 520, the stop part 120 is located in the first space, the connection part 110 is in a pattern formed by the locking member penetrating the second mounting member 222 and the third mounting member 212; the limiting part 111 is an arc groove, and the locking member and/or the third lower mounting member 2121 located at a lower right corner can be relatively displaced with respect to the arc groove. When the locking member is in a first end of the arc groove, the entrance and exit is in the closed state, and when the locking member is in a second end of the arc groove, the entrance and exit is in a fully open state, that is, the door body 100 has rotated to the maximum rotatable range. When the entrance and exit is in the closed state, the first end is located at the lower right of the second end.

It should be noted that, in this embodiment, the connecting part 110 is in the shape of “┘” (an inverted L) shape, the width of the stop part 120 is larger than the maximum width of the connecting part 110, a notch is formed on the left side of the connection between the two, and the locking member located at the lower left corner is in the notch. In other embodiments, the connecting part 110 may also be square, triangular, polygonal, circular, etc., as long as it can be located in the pattern formed by the locking member penetrating the second mounting member 222 and the third mounting member 212, and the mounted stop part 120 can be located in the first space 400 or the second space 300.

Further, in this embodiment, a control board 225 is disposed in the second part of the first driving housing 223; the control board 225 is configured to start the driving motor 221 at a timed time; for example, it can be set to start the driving motor 221 at 8 o'clock in the morning to drive the door body 100 to rotate, so as to make the entrance and exit in the open state, and to start the driving motor 221 at 8 o'clock in the evening to drive the door body 100 to rotate, so as to make the entrance and exit in the closed state. Further, a light sensing device may be disposed on the driving mechanism 220, and the control board 225 is further configured to be turned on upon light sensing, that is, determining according to the intensity of sun rays, i.e., turning on when the sun comes out in the morning and turning off when the sun sets in the evening. Furthermore, in order to avoid an error in the light sensing, for example, in an intermediate time period, due to dark clouds blocking or flashlight irradiation, the error in the light sensing renders erroneous opening and closing of the door, the control board 225 may be further configured to combine the light sensing with timing, for example, the light sensing starts to work one hour after a timed timing point of opening the door and starts to work one hour before a time point of closing the door. In order to deal with some emergencies, it can also be equipped with a remote control. The first driving housing 223 is also provided with a power switch 227, and when the device is required to work, the device can be started by the power switch 227, and at other times, the device can be turned off by the power switch 227, so that the device can be more power-saved.

In this embodiment, the shape of the second driving housing 224 is adapted to an opening of the second part, the driving motor 221 is fixed onto the second driving housing 224, the second driving housing 224 is further provided with a fixing member 2241, where the fixing member 2241 is used for limiting the battery compartment 226 on the second driving housing 224, and after the second driving housing 224 is fixed to the first driving housing 223, the driving motor 221 and the battery compartment 226 are both in the accommodating space of the second part.

In this embodiment, an 18650 lithium battery may be mounted in the battery compartment 226, and a solar panel capable of charging the lithium battery may also be mounted on the driving mechanism 220. Further, in order to avoid situations of rainy days or lacking sun for a long period of time, a charging port 228 is mounted in the first driving housing 223, and emergency charging can be performed through the charging port 228, so that the device works normally.

### Third Embodiment

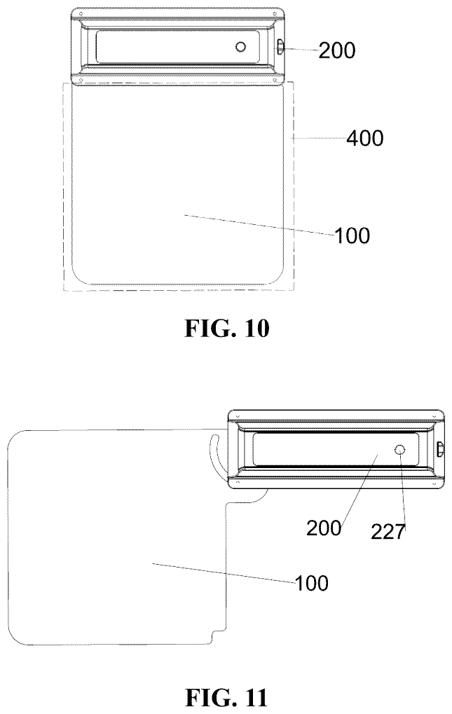

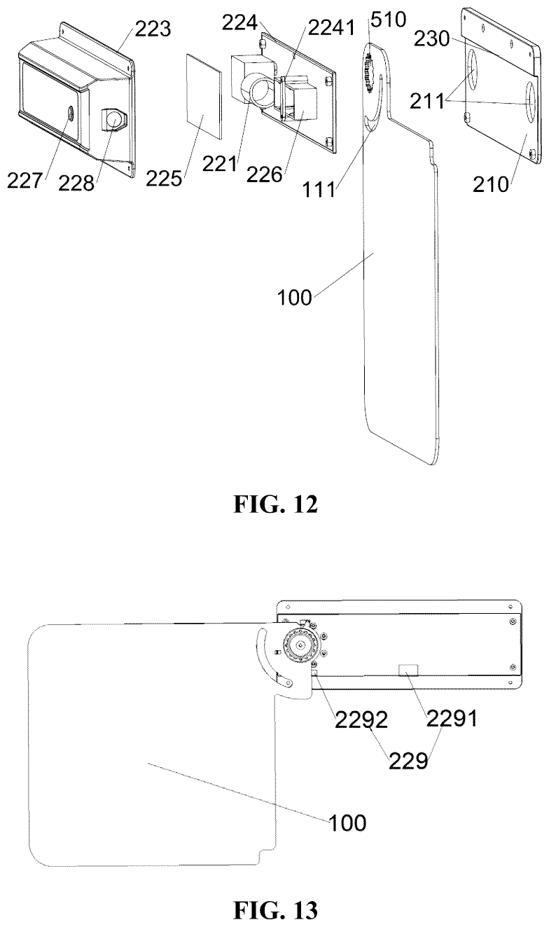

With reference to FIGS. 10 to 12, this embodiment provides an automatically openable and closable door, and in this example, the main difference between the door and the first embodiment is that the mounting mode of the driving mechanism 220 is different, that is, as compared with the direction of the driving mechanism 220 in the first embodiment, the driving mechanism 220 in this embodiment rotates 180 degrees on a vertical plane. Correspondingly, when the door body 100 is connected to the driving motor 221, the door body 100 is mounted in the second space 300, and the driving motor 221 drives the door body 100 to rotate in a clockwise direction to open the door. Other specific structures can be described with reference to the first embodiment, and will not be repeated herein.

### Fourth Embodiment

With reference to FIG. 13, this embodiment provides an automatically openable and closable door. In this embodiment, the main difference between the door and the first embodiment is that the accommodating cavity of the driving mechanism 220 is further provided with a state determining member 229. Other specific structures can be described with reference to the first embodiment, and will not be repeated herein.

As shown in FIG. 13, the state determining member 229 includes a first state determining member 2291 disposed in the middle of the accommodating cavity and a second state determining member 2292 provided at a lower side of the driving motor 221. The first state determining member 2291 is used for determining whether the door body 100 is in a fully closed state, and the second state determining member 2292 is used for determining whether the door body 100 is in a fully open state.

In this embodiment, a micro switch is used as the state determining member 229, and thus, in order to further facilitate the micro switch to determine the state of the door, a first notch corresponding to the first state determining member 2291 and a second notch corresponding to the second state determining member 2292 may be provided in the second driving housing 224, so that the micro switch can touch the door body 100 to determine the state.

It should be noted that, in other embodiments, when the micro switch is used as the state determining member, only the first state determining member 2291 and the first notch may be provided, or only the second state determining member 2292 and the second notch may be provided, and whether the door body 100 is fully in the closed state or the open state is determined according to time. Certainly, in other feasible embodiments, a laser positioning member, a light sensing positioning member, or the like may be used as the state determining member 229, specifically set positions and numbers thereof may also be set according to actual needs, and this specification does not further limit the type, setting position and setting number of the state determining members 229.

In one or more embodiments of this specification, the automatically openable and closable door includes a door body 100, a driving device 200 for driving the door body to rotate, and a transmission mechanism 500 for connecting the door body 100 and the driving device 200. The driving device 200 includes a control mechanism 210 and a driving mechanism 220 mounted to the control mechanism 210, the driving mechanism 220 is provided with a driving motor 221, and upper and lower sides of the driving motor 221 are provided with a first space 400 and a second space 300. After the door body 100 is detachably connected to the driving device 200 through the transmission mechanism 500, if the door body 100 is inserted in the first space 400, the driving motor 221 can drive the door body 100 to rotate clockwise to switch from an initial closed state to the open state. If the door body 100 is inserted in the second space 300, the driving motor may drive the door body 100 to rotate counterclockwise to switch from the initial closed state to the open state. Accordingly, in the automatically openable and closable door provided in this example, the door body 100 is detachably connected to the driving motor 221, and the switching of the door opening mode can be realized by changing the direction in which the door body 100 is connected to the driving motor 221 and the direction in which the driving mechanism 220 is mounted to the control mechanism 210, and the door body 100 is driven by the driving motor 221 to rotate to realize the opening and closing. The size of the door body can be flexibly set in a no-track design, so that the automatically openable and closable door can meet more mounting requirements.

The embodiments above merely express a few implementations of the present invention, and the description thereof is specific and detailed, but should not be understood as limiting the scope of the invention patent. It should be pointed out that for persons having ordinary skill in the art, several modifications and improvements can further be made without departing from the concept of the present invention, which all fall within the scope of protection of the present invention. Therefore, the scope of protection of the present invention patent should be subject to the appended claims.

What is claimed is:

1. An automatically openable and closable door, comprising:
a door body, rotatably disposed to switch between an open state and a closed state;
a driving device, configured to drive the door body to rotate, the driving device comprising a control mechanism and a driving mechanism, the driving mechanism comprising a driving motor, and one side of the driving motor being provided with a first space in which the door body is inserted; and
a transmission mechanism, comprising a first transmission member and a second transmission member, the first transmission member and the second transmission member being respectively disposed on the door body and the driving mechanism and coupled to each other, the second transmission member being connected to the driving motor, and the door body being connected to the driving motor to be driven to rotate; and
wherein after being inserted into the first space, the door body is capable of rotating clockwise or counterclockwise to switch from the closed state to the open state.

2. The automatically openable and closable door according to claim 1, wherein the other side of the driving motor is further provided with a second space;
the door body is inserted into one of the first space and the second space, the door body rotates clockwise or counterclockwise to switch from the closed state to the open state, and the door body is detachably connected with the driving motor, so that the door body is mounted in the first space or the second space.

3. The automatically openable and closable door according to claim 2, wherein the first transmission member is a connecting groove disposed in the door body, and convex teeth are disposed on an inner peripheral wall of the connecting groove; and
the second transmission member comprises an external gear, and the external gear is engaged with the convex teeth.

4. The automatically openable and closable door according to claim 3, wherein the connecting groove is disposed in a thickness direction of the door body in a penetrating manner.

5. The automatically openable and closable door according to claim 4, wherein the second transmission member further comprises a cover plate detachably connected on the external gear, and the control mechanism is provided with a placement groove into which the cover plate extends.

6. The automatically openable and closable door according to claim 2, wherein the control mechanism is provided with a protrusion, and the protrusion protrudes toward the driving mechanism, so as to abut against a back plate of the driving mechanism.

7. The automatically openable and closable door according to claim 6, wherein the protrusion is provided with first mounting members, and the first mounting members are fixing holes; and
the control mechanism and the driving mechanism are respectively provided with second mounting members and third mounting members, the second mounting members and the third mounting members are fixing holes, and the second mounting members and the third mounting members are aligned and matched, so as to mount the driving mechanism to the control mechanism.

8. The automatically openable and closable door according to claim 2, wherein the door body comprises a connecting part and a stop part connected to a lower end of the connecting part, and the first transmission member is disposed on the connecting part.

9. The automatically openable and closable door according to claim 8, wherein the connecting part is further provided with a limiting member for limiting a rotatable range of the door body.

10. The automatically openable and closable door according to claim 2, wherein the driving mechanism comprises a first driving housing and a second driving housing, and the first driving housing and the second driving housing are closed to form an accommodating cavity; and
the driving motor is disposed on one side of the accommodating cavity, the driving motor comprises a connecting shaft extending out of the second driving housing, and the second transmission member is fixed to the connecting shaft.

11. The automatically openable and closable door according to claim 10, wherein the accommodating cavity is further provided with a control board for controlling starting or stopping of the driving motor.

12. The automatically openable and closable door according to claim 10, wherein a battery compartment is provided in the accommodating cavity, and the battery compartment is disposed on the other side of the driving motor.

13. The automatically openable and closable door according to claim 10, wherein the first driving housing or the second driving housing is provided with a power switch.

14. The automatically openable and closable door according to claim 10, wherein the first driving housing or the second driving housing is provided with a charging port communicating with the accommodating cavity.

15. The automatically openable and closable door according to claim 10, wherein the accommodating cavity is provided with a state determining member, and the state determining member comprises a first state determining member for determining whether the door body is in a fully closed state and a second state determining member for determining whether the door body is in a fully open state.
